(19) United States
(12) Patent Application Publication
(10) Pub. No.: US 2013/0068500 A1
(43) Pub. Date: Mar. 21, 2013

(54) INSULATED WIRE

(71) Applicants: Sun-Joo Park, Gunpo-si (KR); Joon-Hee Lee, Gunpo-si (KR); Dong-Jin Seo, Gunpo-si (KR)

(72) Inventors: Sun-Joo Park, Gunpo-si (KR); Joon-Hee Lee, Gunpo-si (KR); Dong-Jin Seo, Gunpo-si (KR)

(73) Assignee: LS Cable & System Ltd., Anyang-city (KR)

(21) Appl. No.: 13/701,675

(22) PCT Filed: Jun. 3, 2011
(86) PCT No.: PCT/KR2011/004099

§ 371 Date: Dec. 3, 2012

(30) Foreign Application Priority Data
Jun. 3, 2010 (KR) 10-2010-0052376
Jun. 3, 2011 (KR) 10-2011-0053987

(51) Int. Cl. H01B 3/30

(52) U.S. Cl. 174/120 SR

(57) ABSTRACT

The present invention provides an insulated wire having a conductor and at least two insulating coating layers formed surrounding the conductor, wherein the insulating coating layers comprises the outermost layer thereof, which has a thickness in the range of 20 to 50% based on the total thickness of the insulating coating layers and comprises a polyimide resin; and a base insulating coating layer in contact with the conductor, which has a thickness in a range of 50 to 80% based on the total thickness of the insulating coating layers and comprises a polyamide-imide resin having an adhesion-improving agent. The insulated wire of the present invention has insulating coating layers having superior coating adhesion as well as good heat-resistance.

### TECHNICAL FIELD

The present invention relates to an insulated wire.

### BACKGROUND ART

The present application claims priority to Korean Patent Application No. 10-2010-0052376 filed in the Republic of Korea on Jun. 3, 2010, the disclosure of which is incorporated herein by reference.

Also, the present application claims priority to Korean Patent Application No. 10-2011-0053987 filed in the Republic of Korea on Jun. 3, 2011, the disclosure of which is incorporated herein by reference.

An insulated wire is obtained by coating conductors with an insulating material on the surrounding thereof, followed by drying, so that electricity does not flow between each conductor, and is used as a coil for various electrical equipments such as a transformer and a rotary machine. A commonly used insulating material may include polyurethane, polyester, polyesterimide, polyamide-imide, and polyimide, alone or as a mixture thereof. Particularly, a coil for a vehicle generator may be made of an insulated wire obtained by first forming an insulating coating film of polyesterimide surrounding a conductor and then coating polyamide-imide thereon; or an insulated wire obtained by forming only an insulating coating film of polyamide-imide surrounding a conductor. Also, in order to provide good heat-resistance and mechanical strength, an insulated wire coated with only polyimide may be used.

Recently, the trend to miniaturize and lighten the weight of electrical equipments is on the rise. To meet this demand, a highly-integrated efficient output motor are required, and may be prepared by using an insulated flat wire to remove a pore space between insulated wires which is generated upon winding a conventional circular insulated wire, thereby increasing a space factor of a motor core. However, there are problems in preparing a motor coil using an insulated flat wire in that it is difficult to continuously wind a long insulated wire in the slot of the motor core or to insert an insulated winding wire in the slot of the motor core, unlike the use of an insulated round wire. Accordingly, the long insulated wire is cut in a certain length to suitably adapt in the slot of the motor core before being inserted in the slot, and then each insulated wire terminal comes in contact with each other to form the entire circuit, i.e., so-called a hair-pin method is carried out. The contact of the insulated wire terminals is generally carried out by means of an electrical welding method such as a TIG welding. In the electrical welding method, high-temperature heat higher than a melting point is applied to a conductor, and is transmitted to an insulating coating film around the conductor.

Due to high-temperature heat generated during the electrical welding, conventional insulated wires are pyrolyzed and discolored. Such a thermal decomposition of the insulation coating causes the generation of gas, and the rapid evaporation of water absorbed or a solvent remaining in the insulating coating film to swell or blister the insulating coating film, thereby reducing the reliability of the insulated wires. Also, an insulated wire having a coating layer made of a polyimide resin exhibiting higher heat-resistance than those of polyester or polyesterimide resins has poor adhesion between a conductor and the polyimide resin coating film, resulting in swelling or blistering of the insulating coating layer.

### DISCLOSURE

### Technical Problem

The present invention is designed to solve the problems of the prior art, and therefore it is an object of the present invention to produce an insulated coating film structure having superior adhesion and high heat-resistance, thereby providing good reliability during a welding process.

### Technical Solution

In order to accomplish the above object, the present inventors have endeavored to develop an insulated wire capable of providing good reliability during a welding process and found that good adhesion between a conductor and the innermost insulating coating film is required together with the high heat-resistance of insulating coating resins.

In accordance with one aspect of the present invention, there is provided an insulated wire having a conductor and at least two insulating coating layers formed surrounding the conductor, wherein the insulating coating layers comprises an outermost layer, which has a thickness in the range of 20 to 50% based on the total thickness of the insulating coating layers and comprises a polyimide resin; and a base insulating coating layer in contact with the conductor, which has a thickness in a range of 50 to 80% based on the total thickness of the insulating coating layers and comprises a polyamide-imide resin having an adhesion-improving agent. Also, the polyimide resin of the outermost layer may further comprise an amide, and the molar ratio of the imide and the amide in the polyimide resin is in the range of 0.01:99.99 to 10:90.

Preferably, the outermost layer is pyrolyzed in the range of 5 wt % or less at a temperature of 500° C. or higher, and the base insulating coating layer is pyrolyzed in the range of 5 wt % or less at a temperature of 400° C. or higher.

The adhesion-improving agent may be a melamine resin which is self-condensed in the range of 20% or less during a hardening process. In addition, the content of the adhesion-improving agent may be in the range of 0.05 to 2 wt % based on the total weight of the polyamide-imide resin comprising the adhesion-improving agent.

### Advantageous Effects

In accordance with the present invention, the insulating coating layers of the insulated wire have superior coating adhesion as well as good heat-resistance.

### DESCRIPTION OF DRAWINGS

The accompanying drawings illustrate preferred embodiments of the present invention and, together with the foregoing disclosure, serve to provide further understanding of the technical spirit of the present disclosure. However, the present disclosure is not to be construed as being limited to the drawings.

FIG. 1 schematically shows a cross-section of an insulated wire having two insulating coating layers according to one embodiment of the present invention.

### EXPLANATION OF NUMERICAL SIGNALS

10: Insulated wire 11: Conductor
12: Base insulating layer comprising a polyamide-imide resin having an adhesion-improving agent
13: Outermost layer comprising a polyimide resin

### BEST MODE

Hereinafter, the present invention will be described in detail. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

The insulated wire of the present invention has a conductor and at least two insulating coating layers formed surrounding the conductor, wherein the insulating coating layers comprises an outermost layer, which has a thickness in the range of 20 to 50% based on the total thickness of the insulating coating layers and comprises a polyimide resin; and a base insulating coating layer in contact with the conductor, which has a thickness in a range of 50 to 80% based on the total thickness of the insulating coating layers and comprises a polyamide-imide resin having an adhesion-improving agent.

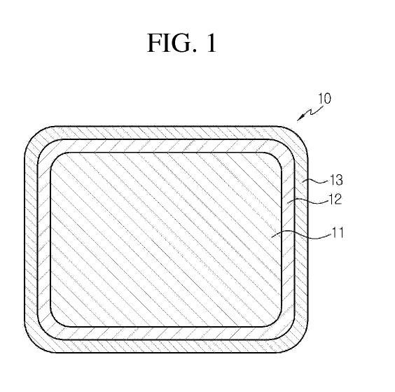

Referring to FIG. 1, the insulated wire of the present invention has at least two insulating coating layers. In one embodiment of the present invention, an insulated wire 10 having two insulating coating layers comprises a conductor 11, a base insulating layer 12 surrounding the conductor, which comprises a polyamide-imide resin having an adhesion-improving agent, and the outermost layer 13 comprising a polyimide resin. The polyimide resin of the outermost layer 13 may further comprise an amide group, and in the polyimide resin, the molar ratio of the amide group and the imide group may be in the range of 0.01:99.99 to 10:90.

The polyimide resin used in the outermost layer of the insulating coating layers may be prepared by polycondensing an acid dianhydride, or a polybasic acid or its anhydride with a diamine component in an organic solvent for imidization, and the content of the acid dianhydride, polybasic acid or its anhydride may be adjusted to control the ratio of the amide group and the imide group in the insulating resin. In the present invention, it is preferred that the diamine is used in a ratio of 0.7 to 1.3, preferably 0.8 to 1.2 relative to the acid dianhydride, polybasic acid or its anhydride. When the diamine is used in a ratio less than 0.7 or higher than 1.3, relative to the acid dianhydride, polybasic acid or its anhydride, it is difficult to obtain a resin having good heat-resistance. Specific examples of the acid anhydride used in the preparation of the polyimide resin used in the outermost layer of the insulating coating layers may include pyromellitic acid dianhydride, 3,3′,4,4′ biphenyltetracarbonic acid dianhydride, 2,3′,3,4′-biphenyltetracarbonic acid dianhydride, 3.3′,4,4′-benzophenone-tetracarbonic acid dianhydride, 2,3,6,7,-naphthalenedicarboxylic acid dianhydride, 2,2-bis(3,4-dicarboxylphenyl)ether, pyridine-2,3,5,6-tetracarbonic acid dianhydride, 1,2,4,5-naphthalenetetracarbonic acid dianhydride, 1,4,5,8-naphthalenetetracarbonic acid dianhydride, 1,4,5,8-decahydronaphthalenetetracarbonic acid dianhydride, 4,8-dimethyl-1,2,5,6-hexahydronaphthalenetetracarbonic acid dianhydride, 2,6-dichloro-1,4,5,8-naphthalenetetracarbonic acid dianhydride, 2,7-dichloro-1,4,5,8,-naphthalene tetracarbonic acid dianhydride, 2,3,6,7-tetrachloro-1,4,5,8-naphthalenetetracarbonic acid dianhydride, 1,8,9,10-phenanthrenetetracarbonic acid dianhydride, 2,2-bis(2,3-dicarboxylphenyl)propane dianhydride, 1,1-bis(3,4-dicarboxylphenyl)ethane dianhydride, 1,1-bis(2,3-dicarboxylphenyl)ethane dianhydride, bis(2,3-dicarboxylphenyl)methane dianhydride, bis(3,4,-dicarboxylphenyl)methane dianhydride, bis(3,4-dicarboxylphenyl)sulfone dianhydride, benzene-1,2,3,4-tetracarbonic acid dianhydride, and 3,4,3′,4′-benzophenone-tetracarbonic acid dianhydride, which are not particularly limited unless causing the deterioration of heat-resistance. Also, these acid anhydrides may be used alone or in a mixture thereof.

The polybasic acid and its anhydride used in the preparation of the polyimide resin used in the outermost layer of the insulating coating layers may be a conventional polybasic acid and its anhydride, for example, tribasic acid such as trimellitic acid, trimellitic anhydride, trimellitic chloride and a derivative of trimellitic acid, which are not particularly limited unless causing the deterioration of heat-resistance. Specific examples of the diamine used in the preparation of the polyimide resin used in the outermost layer of the insulating coating layers may include paraphenylenediamine, metaphenylenediamine, 4,4′-diaminodiphenylether, 3,4′-diaminodiphenylether, 3,3′-diaminodiphenylether, 4,4′-diaminodiphenylpropane, 3,4′-diaminodiphenylpropane, 3,3′-diaminodiphenylpropane, 4,4′-diaminodiphenylmethane, 3,4′-diaminodiphenylmethane, 3,3′-diaminodiphenylmethane, benzidine, 4,4′-diaminodiphenylsulfide, 3,4′-diaminodiphenylsulfide, 3,3′-diaminodiphenylsulfide, 4,4′-diaminodiphenylsulfone, 3,4′-diaminodiphenylsulfone, 3,3′-diaminodiphenylsulfone, 2,6-diaminopyridine, bis-(4-aminophenyl)diethylsilane, 3,3′-dichlorobenzidine, bis-(4-aminophenyl)ethylphosphine oxide, bis-aminonaphthalene, 3,3′-dimethyl-4,4′-diaminobiphenyl, 3,4′-dimethyl-3′,4-diaminobiphenyl, 3,3′-dimethoxybenzidine, 2,4-bis(p-β-amino-t-butylphenyl)ether, bis(p-β-amino-t-butylphenyl)ether, p-bis(2-methyl-4-aminopentyl)benzene, p-bis(1,1-dimethyl-5-aminopentyl)benzene, m-xylenediamine, p-xylenediamine, 1,3-diaminoadamantane, 3,3′-diamino-1,1′-diaminoadamantane, 3,3′-diaminomethyl 1,1′-diadamantane, bis(p-aminocyclohexyl)methane, hexamethylenediamine, heptamethylenediamine, octamethylenediamine, nonamethylenediamine, decamethylenediamine, 3-methylheptamethylenediamine, 4,4′-dimethylheptamethylenediamine, 2,11-diaminododecane, 1,2-bis(3-aminopropoxy)ethane, 2,2-dimethylpropylenediamine, 3-methoxyhexaethylenediamine, 2,5-dimethylhexamethylenediamine, 2,5-diamino-1,3,4-oxadiazole, 2,2-bis(4-aminophenyl)hexafluoropropane, N-(3-aminophenyl)-4-aminobenzoamide, 4-aminophenyl-3-aminobenzoate, which are not particularly limited unless causing the deterioration of heat-resistance. Also, these diamines may be used alone or in a mixture thereof.

Also, specific examples of the organic solvent used in the preparation of the polyimide resin used in the outermost layer of the insulating coating layers may include a sulfoxide-based solvent such as dimethyl sulfoxide and diethylsulfoxide, a formamide-based solvent such as N,N-dimethyl formamide and N,N-diethyl formamide, an acetamide-based solvent such as N,N-dimethylacetamide and N,N-diethylacetamide, a pyrrolidone-based solvent such as N-methyl-2-pyrrolidone and N-vinyl-2-pyrrolidone, a phenol-based solvent such as phenol, o-, m- or p-cresol, xylenole, halogenated phenol and catechol, and a polar aprotic solvent such as hexamethylphosphoramide and γ-butyrolactone, but are not limited thereto. Also, these solvents may be used alone or in a mixture thereof.

Alternatively, the polyimide resin used in the outermost layer of the insulating coating layers may be prepared by polycondensing an acid dianhydride, or a polybasic acid or its anhydride with a diisocyanate component in an organic solvent for imidization, and the content of the acid dianhydride, polybasic acid or its anhydride may be adjusted to control the ratio of the amide group and the imide group in the insulating resin. In the present invention, it is preferred that the diisocyanate is used in a ratio of 0.7 to 1.3, preferably 0.8 to 1.2 relative to the acid dianhydride, polybasic acid or its anhydride. When the diisocyanate is used in a ratio less than 0.7 or higher than 1.3, relative to the acid dianhydride, polybasic acid or its anhydride, it is difficult to obtain a resin having good heat-resistance. Specific examples of the acid anhydride used in the preparation of the polyimide resin used in the outermost layer of the insulating coating layers may include pyromellitic acid dianhydride, 3,3′,4,4′-biphenyltetracarbonic acid dianhydride, 2,3′,3,4′-biphenyltetracarbonic acid dianhydride, 3,3′,4,4′-benzophenone-tetracarbonic acid dianhydride, 2,3,6,7,-naphthalenedicarboxylic acid dianhydride, 2,2-bis(3,4-dicarboxylphenyl)ether, pyridine-2,3,5,6-tetracarbonic acid dianhydride, 1,2,4,5-naphthalenetetracarbonic acid dianhydride, 1,4,5,8-naphthalenetetracarbonic acid dianhydride, 1,4,5,8-decahydronaphthalenetetracarbonic acid dianhydride, 4,8-dimethyl-1,2,5,6-hexahydronaphthalenetetracarbonic acid dianhydride, 2,6-dichloro-1,4,5,8-naphthalenetetracarbonic acid dianhydride, 2,7-dichloro-1,4,5,8,-naphthalenetetracarbonic acid dianhydride, 2,3,6,7-tetrachloro-1,4,5,8-naphthalenetetracarbonic acid dianhydride, 1,8,9,10-phenanthrenetetracarbonic acid dianhydride, 2,2-bis(2,3-dicarboxylphenyl)propane dianhydride, 1,1-bis(3,4-dicarboxylphenyl)ethane dianhydride, 1,1-bis(2,3-dicarboxylphenyl)ethane dianhydride, bis(2,3-dicarboxylphenyl)methane dianhydride, bis(3,4,-dicarboxylphenyl)methane dianhydride, bis(3,4-dicarboxylphenyl)sulfone dianhydride, benzene-1,2,3,4-tetracarbonic acid dianhydride, and 3,4,3′,4′-benzophenone-tetracarbonic acid dianhydride, which are not particularly limited unless causing the deterioration of heat-resistance. Also, these acid anhydrides may be used alone or in a mixture thereof.

The polybasic acid and its anhydride used in the preparation of the polyimide resin used in the outermost layer of the insulating coating layers may be a conventional polybasic acid and its anhydride, for example, tribasic acid such as trimellitic acid, trimellitic anhydride, trimellitic chloride and a derivative of trimellitic acid, which are not particularly limited unless causing the deterioration of heat-resistance.

Specific examples of the diisocyanate used in the preparation of the polyimide resin used in the outermost layer of the insulating coating layers may include diphenylmethane-4,4′-diisocyanate, diphenylmethane-3,3′-diisocyanate, diphenylmethane-3,4′-diisocyanate, diphenylether-4,4′-diisocyanate, benzophenone-4,4′-diisocyanate, diphenylsulfone-4,4′-diisocyanate, tolylene-2,4-diisocyanate, tolylene-2,6-diisocyanate, m-xylene diisocyanate, and p-xylene diisocyanate, which are not particularly limited unless causing the deterioration of heat-resistance. Also, these diamines may be used alone or in a mixture thereof.

Also, specific examples of the organic solvent used in the preparation of the polyimide resin used in the outermost layer of the insulating coating layers may include a sulfoxide-based solvent such as dimethyl sulfoxide and diethylsulfoxide, a formamide-based solvent such as N,N-dimethyl formamide and N,N-diethyl formamide, an acetamide-based solvent such as N,N-dimethylacetamide and N,N-diethylacetamide, a pyrrolidone-based solvent such as N-methyl-2-pyrrolidone and N-vinyl-2-pyrrolidone, a phenol-based solvent such as phenol, o-, m- or p-cresol, xylenole, halogenated phenol and catechol, and a polar aprotic solvent such as hexamethylphosphoramide and γ-butyrolactone, but are not limited thereto. Also, these solvents may be used alone or in a mixture thereof.

The polyimide resin thus prepared is used in the outermost layer 13 of the insulating coating layers. The outermost layer has a thickness in the range of 20 to 50% based on the total thickness of the insulating coating layers.

Also, in the present invention, the polyamide-imide resin used in the base insulating layer in contact with the conductor may be one prepared in a thermal solution polymerization, for example, by thermally polymerizing an aromatic diisocyanate or a diamine with a polybasic acid or its anhydride in an organic solvent. At this time, it is preferred that the polybasic acid or its anhydride is used in a ratio of 0.7 to 1.3, preferably 0.8 to 1.2 relative to the diisocyanate. When the polybasic acid or its anhydride is used in a ratio less than 0.7 or higher than 1.3, relative to the diisocyanate, it is difficult to obtain the sufficient thermal property and other conventional good properties of the polyamide-imide resin.

Specific examples of the aromatic diisocyanate may include diphenylmethane-4,4′-diisocyanate, diphenylmethane-3,3′-diisocyanate, diphenylmethane-3,4′-diisocyanate, diphenylether-4,4′-diisocyanate, benzophenone-4,4′-diisocyanate, diphenylsulfone-4,4′-diisocyanate, tolylene-2,4-diisocyanate, tolylene-2,6-diisocyanate, m-xylene diisocyanate, and p-xylene diisocyanate, which are not particularly limited unless causing the deterioration of heat-resistance. Also, these diamines may be used alone or in a mixture thereof. Among these, diphenylmethane-4,4′-diisocyanate is preferred in terms of easy purchase and moderate prices.

The polybasic acid and its anhydride used in the preparation of the polyamide-imide resin of the base insulating layer may be a conventional polybasic acid and its anhydride, for example, tribasic acid such as trimellitic acid, trimellitic anhydride, trimellitic chloride and a derivative of trimellitic acid, which are not particularly limited unless causing the deterioration of heat-resistance.

The organic solvent used in the preparation of the polyamide-imide resin of the base insulating layer may be N-methyl-2-pyrrolidone, dimethylacetamide or N,N-dimethyl formamide, preferably N-methyl-2-pyrrolidone, but is not limited thereto. Also, these organic solvents may be used alone or in a mixture thereof.

The polyamide-imid resin thus prepared is used in the base insulating layer 12 in contact with the conductor and may comprise an adhesion-improving agent. The base insulating layer has a thickness in the range of 50 to 80% based on the total thickness of the insulating coating layers.

The adhesion-improving agent used in the insulated wire of the present invention may be a melamine resin of the following formula I which is self-condensed in the range of 20% or less during a hardening process. If the adhesion-improving agent is self-condensed in the range higher than 20%, it is difficult to obtain sufficient adhesion between the conductor and the resin layer.

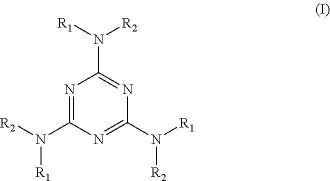

wherein,

R₁ and R₂ are each independently the same or different, and

R₁ is H or CH₂OR′,

R′ is H, CH₃ or C₄H₉,

R₂ is H or CH₂OR″; and

R″ is H or CH₃.

The melamine resin of formula I may exist in a monomer, dimer, trimer, multimer or a mixture thereof, and among these, the mixture is preferably used in the present invention.

In addition, the adhesion-improving agent may be used in an amount of 0.05 to 2 wt % based on the total weight of the polyamide-imide resin comprising the adhesion-improving agent. If the content of the adhesion-improving agent is less than 0.05 wt %, an adhesion effect is insufficient. If the content of the adhesion-improving agent is higher than 2 wt %, an excessive amount of adhesion-improving agent is present to substantially cause the deterioration of adhesion.

Hereinafter, the present invention will be explained in more detail with reference to the following Examples. However, it should be understood that the Examples are provided for the purpose of illustrations only and to better explain to a person having ordinary skill in the art, and is not intended to limit the scope of the present invention, so other equivalents and modifications could be made thereto without departing from the spirit and scope of the present invention.

### EXAMPLES

### Preparation Example 1

### Synthesis of Polyimide Resin in which the Molar Ratio of the Amide Group and the Imide Group is 0:100 (Outermost Layer 1)

In a four-neck flask equipped with a stirrer and a condenser, which is dried well at room temperature, 81.7 parts by weight of 4,4′-diaminodiphenyl ether were dissolved in 560.6 parts by weight of N-methylpyrrolidon. After completely dissolving 4,4′-diaminodiphenyl ether, 87.2 parts by weight of pyromellitic dianhydride was added and stirred for 12 hours, to obtain a polyimide resin in which the molar ratio of an amide and an imide is 0:100.

### Preparation Example 2

### Synthesis of Polyimide Resin in which the Molar Ratio of Amide Group and Imide Group is 10:90 (Outermost Layer 2)

In a four-neck flask equipped with a stirrer and a condenser, which is dried well at room temperature, 62.5 parts by weight of diphenylmethane-4,4′-diisocyanate (MDI), 9.8 parts by weight of trimellitic anhydride (TMA) and 44.5 parts by weight of pyromellitic acid anhydride were dissolved in 531.8 parts by weight of N-methyl pyrrolidone. The temperature of the reaction was raised to 160° C. in 8 hours, to obtain a polyimide resin in which the molar ratio of an amide and an imide is 10:90.

### Preparation Example 3

### Synthesis of Polyimide Resin in which the Molar Ratio of Amide Group and Imide Group is 75:25 (Outermost Layer 3)

In a four-neck flask equipped with a stirrer and a condenser, which is dried well at room temperature, 62.5 parts by weight of diphenyl methane-4,4′-diisocyanate (MDI), 24.5 parts by weight of trimellitic anhydride (TMA) and 27.8 parts by weight of pyromellitic acid anhydride were dissolved in 520.5 parts by weight of N-methyl pyrrolidone. The temperature of the reaction was raised to 160° C. in 8 hours, to obtain a polyimide resin in which the molar ratio of an amide and an imide is 75:25.

### Preparation Example 4

### Synthesis of Polyamide-Imide Resin (Base Layer 1)

In a four-neck flask equipped with a stirrer and a condenser, which is dried well at room temperature, 201 parts by weight of trimellitic dianhydride were dissolved in 510.0 parts by weight of N-methylpyrrolidone. Thereto, 250 parts by weight of diphenylmethane-4,4′-diisocyanate (MDI) was added, and the reaction temperature slowly increased from 80° C. to 140° C., to produce a polyamide-imide resin. To 100 parts by weight of the resulting polyamide-imide resin, 0.5 parts by weight of a hexamethylmethoxy melamine resin was added and stirred, to obtain a polyamide-imide resin having a melamine resin.

### Preparation Example 5

### Synthesis of Polyamide-Imide Resin (Base Layer 2)

In a four-neck flask equipped with a stirrer and a condenser, which is dried well at room temperature, 201 parts by weight of trimellitic dianhydride were dissolved in 510.0 parts by weight of N-methylpyrrolidone. Thereto, 250 parts by weight of diphenylmethane-4,4′-diisocyanate (MDI) was added, and the reaction temperature slowly increased from 80° C. to 140° C., to produce a polyamide-imide resin. To 100 parts by weight of the resulting polyamide-imide resin, 0.1 parts by weight of a hexamethylmethoxy melamine resin was added and stirred, to obtain a polyamide-imide resin having a melamine resin.

### Preparation Example 6

### Synthesis of Polyamide-Imide Resin (Base Layer 3)

In a four-neck flask equipped with a stirrer and a condenser, which is dried well at room temperature, 201 parts by weight of trimellitic dianhydride were dissolved in 510.0 parts by weight of N-methylpyrrolidone. Thereto, 250 parts by weight of diphenylmethane-4,4′-diisocyanate (MDI) was added, and the reaction temperature slowly increased from 80° C. to 140° C., to produce a polyamide-imide resin. To 100 parts by weight of the resulting polyamide-imide resin, 1 part by weight of a hexamethylmethoxy melamine resin was added and stirred, to obtain a polyamide-imide resin having a melamine resin.

### Preparation Example 7

### Synthesis of Polyamide-Imide Resin (Base Layer 4)

In a four-neck flask equipped with a stirrer and a condenser, which is dried well at room temperature, 201 parts by weight of trimellitic dianhydride were dissolved in 510.0 parts by weight of N-methylpyrrolidone. Thereto, 250 parts by weight of diphenylmethane-4,4′-diisocyanate (MDI) was added, and the reaction temperature slowly increased from 80° C. to 140° C., to produce a polyamide-imide resin. To 100 parts by weight of the resulting polyamide-imide resin, 0.5 parts by weight of a trimethoxy melamine resin was added and stirred, to obtain a polyamide-imide resin having a melamine resin.

### Preparation Example 8

### Synthesis of Polyamide-Imide Resin (Base Layer 5)

In a four-neck flask equipped with a stirrer and a condenser, which is dried well at room temperature, 136.6 parts by weight of trimellitic dianhydride were dissolved in 510.8 parts by weight of N-methylpyrrolidone. Thereto, 254 parts by weight of diphenylmethane-4,4′-diisocyanate (MDI) was added, and the reaction temperature slowly increased from 80° C. to 140° C., to produce a polyamide-imide resin. To 100 parts by weight of the resulting polyamide-imide resin, 0.5 parts by weight of a hexamethoxy melamine resin was added and stirred, to obtain a polyamide-imide resin having a melamine resin.

### Preparation Example 9

### Synthesis of Polyamide-Imide Resin (Base Layer 6)

In a four-neck flask equipped with a stirrer and a condenser, which is dried well at room temperature, 201 parts by weight of trimellitic dianhydride were dissolved in 510.0 parts by weight of N-methylpyrrolidone. Thereto, 250 parts by weight of diphenylmethane-4,4′-diisocyanate (MDI) was added, and the reaction temperature slowly increased from 80° C. to 140° C., to obtain a polyamide-imide resin.

### Example 1

On a straight-angle oxygen-free copper conductor having a size of 1.5'2.0 mm (thickness×width) with a corner radius R of 0.5 mm, the polyamine-imide resin obtained in Preparation Example 4 (base layer 1) was coated, followed by heating and drying, to form an insulating coating film having a thickness of 16 μm. Then, on the coated polyamine-imide resin, the polyimide resin obtained in Preparation Example 1 (outermost layer 1) was coated followed by heating and drying, to form an insulating coating film having a thickness of 24 μm. Thereby, a straight-angle insulated wire having a total thickness of 40 μm was prepared.

### Examples 2 to 7

The procedure of Example 1 was repeated using the components and ratios shown in Table 1.

### Comparative Examples 1 to 5

The procedure of Example 1 was repeated using the components and ratios shown in Table 1.

TABLE 1

| | Example | | | | | | | Comparative Example | | | | |
|---|---|---|---|---|---|---|---|---|---|---|---|---|
| | 1 | 2 | 3 | 4 | 5 | 6 | 7 | 1 | 2 | 3 | 4 | 5 |
| Base | 32 | 26 | 20 | 26 | 26 | 26 | 26 | 36 | 16 | 26 | 26 | 26 |
| layer | Base | Base | Base | Base | Base | Base | Base | Base | Base | Base | Base | Base |
| (μm) | layer 1 | layer 1 | layer 1 | layer 1 | layer 2 | layer 3 | layer 4 | layer 1 | layer 1 | layer 1 | layer 5 | layer 6 |
| Outer- | 8 | 14 | 20 | 14 | 14 | 14 | 14 | 4 | 24 | 14 | 14 | 14 |
| most | Outer- | Outer- | Outer- | Outer- | Outer- | Outer- | Outer- | Outer- | Outer- | Outer- | Outer- | Outer- |
| layer | most | most | most | most | most | most | most | most | most | most | most | most |
| (μm) | layer 1 | layer 1 | layer 1 | layer 2 | layer 1 | layer 1 | layer 1 | layer 1 | layer 1 | layer 3 | layer 1 | layer 1 |

### Experimental Example

### Evaluation of Properties

### <Torsion Test>

The insulated wires prepared in Examples 1 to 7 and Comparative Examples 1 to 5 were evaluated for their adhesion. Each specimen having a length of about 50 cm was fastened at the end of a torsion tester, to which a load of 800 g was applied, before operating the tester. The number of revolutions was measured when the coating film of each specimen was broken off, and shown in Table 2.

### <Flexibility Test>

The insulated wires prepared in Examples 1 to 7 and Comparative Examples 1 to 5 were evaluated for their film flexibility. Each specimen having a length of about 40 cm was made in an elongated S-shape by bending in a angle of 180° in both directions using a mandrel bend tester, and was observed for its crack and/or peeling. Such a procedure was repeated 3 times for each plane of thickness and width, and each minimum mandrel diameter d (mm) in which no crack or peeling occurred was measured and shown in Table 2.

### <Cut-Through>

The insulated wires prepared in Examples 1 to 7 and Comparative Examples 1 to 5 were evaluated for their thermal resistance. On the width plane of each specimen having a length of about 20 cm, a 1.6 mm-diameter steel ball having smooth surface was placed, to which a load of 1000 g was applied, followed by immersing in a thermostatic bath and measuring for its cut-through temperature. The results thereof were shown in Table 2.

### <Welding Test>

The insulated wires prepared in Examples 1 to 7 and Comparative Examples 1 to 5 were evaluated for their welding property. Each specimen having a length of about 5 cm was prepared, and its coating film was removed by 4.5 mm from the end thereof and mounted in a welding test instrument perpendicular to a welding torch. A welding test was carried out, then the size of blisters generated in the coating film of each specimen and the discoloration length of the coating film were measured and shown in Table 2.

TABLE 2

| | Example | | | | | | | Comparative Example | | | | |
|---|---|---|---|---|---|---|---|---|---|---|---|---|
| | 1 | 2 | 3 | 4 | 5 | 6 | 7 | 1 | 2 | 3 | 4 | 5 |
| Torsion (number) | 86 | 84 | 78 | 85 | 80 | 87 | 84 | 89 | 53 | 76 | 55 | 46 |
| Flexibility | 1d | 1d | 1d | 1d | 1d | 1d | 1d | 1d | 2d | 1d | 2d | 3d |
| Cut through | 412 | 419 | 425 | 418 | 421 | 414 | 419 | 403 | 428 | 354 | 398 | 415 |
| Temperature ( ) | | | | | | | | | | | | |
| Size of Blister(mm) | 0.83 | 0.71 | 0.62 | 0.73 | 0.70 | 0.74 | 0.73 | 1.23 | 1.12 | 1.31 | 1.28 | 1.62 |
| Discoloration | 3.66 | 3.10 | 2.76 | 3.13 | 3.05 | 3.27 | 3.15 | 4.32 | 3.02 | 4.89 | 4.76 | 4.13 |
| length(mm) | | | | | | | | | | | | |

As shown in Table 2, the insulated wire of Examples 1 to 7 exhibit good test results. Particularly, in the welding test, the discoloration length is less than 4.0 mm and the blister size is less than 1.0 mm. In contrast, the insulated wire of Comparative Example 1 exhibits poor welding test results as the thickness ratio of the base layer 1 is low, and the insulated wire of Comparative Example 2 fails to have suitable adhesion as the thickness ratio of the outermost layer 2 is low. In the case of Comparative Example 3, the resin consisting of the outermost layer exhibits insufficient thermal resistance. The insulated wire of Comparative Example 4 becomes greatly damaged in the welding test due to the low thermal resistance of the base resin layer. The insulated wire of Comparative Example 5 exhibits low adhesion as the insulating coating layer has no an adhesion-improving agent, thereby generating large blisters in the welding test.

What is claimed is:

1. An insulated wire having a conductor and at least two insulating coating layers formed surrounding the conductor, wherein the insulating coating layers comprises:
an outermost layer, which has a thickness in the range of 20 to 50% based on the total thickness of the insulating coating layers and comprises a polyimide resin; and
a base insulating coating layer in contact with the conductor, which has a thickness in a range of 50 to 80% based on the total thickness of the insulating coating layers and comprises a polyamide-imide resin having an adhesion-improving agent.

2. The insulated wire according to claim 1, wherein the polyimide resin of the outermost layer further comprises an amide group, and the molar ratio of the imide group and the amide group in the polyimide resin is in the range of 0.01:99.99 to 10:90.

3. The insulated wire according to claim 1 or 2, wherein the outermost layer is pyrolyzed in the range of 5 wt % or less at a temperature of 500° C. or higher.

4. The insulated wire according to claim 1 or 2, wherein the base insulating coating layer is pyrolyzed in the range of 5 wt % or less at a temperature of 400° C. or higher.

5. The insulated wire according to claim 1 or 2, wherein the adhesion-improving agent is a melamine resin which is self-condensed in the range of 20% or less during a hardening process.

6. The insulated wire according to claim 1 or 2, wherein the content of the adhesion-improving agent is in the range of 0.05 to 2 wt % based on the total weight of the polyamide-imide resin comprising the adhesion-improving agent.
